(19) United States
(12) Patent Application Publication
(10) Pub. No.: US 2020/0315225 A1
(43) Pub. Date: Oct. 8, 2020

(54) Crispy-Crunchy Fruit and Vegetable Products

(71) Applicant: Ocean Spray Cranberries, Inc., Lakeville-Middleboro, MA (US)

(72) Inventors: Barbara Vazquez Del Mercado, Lakeville-Middleboro, MA (US); Soumya Roy, Lakeville-Middleboro, MA (US); Kellie Denson, Lakeville-Middleboro, MA (US); Min Blundell, Lakeville-Middleboro, MA (US)

(21) Appl. No.: 16/762,001

(22) PCT Filed: Nov. 6, 2018
(86) PCT No.: PCT/US2018/059507

§ 371 Date: May 6, 2020

Related U.S. Application Data
(60) Provisional application No. 62/700,788, filed on Jul. 19, 2018.
(60) Provisional application No. 62/582,287, filed on Nov. 6, 2017.

(51) Int. Cl. A23L 19/00; A23B 7/02; A23B 7/08; A23L 5/10; A23P 30/32; A23L 5/30

(52) U.S. Cl. CPC A23L 19/03; A23B 7/02; A23B 7/085; A23V 2002/00; A23L 5/12; A23P 30/32; A23L 5/30; A23L 5/17

(57) ABSTRACT

The present specification provides fruit and vegetable products. Also described are methods for producing the fruit and vegetable products.

### CROSS-REFERENCE TO RELATED APPLICATIONS

This application claims the benefit of priority under 35 U.S.C. Section 119(e) to U.S. Provisional Patent Application No. 62/700,788, filed on Jul. 19, 2018 and U.S. Provisional Patent Application No. 62/582,287, filed on Nov. 6, 2017, the contents of which are hereby incorporated by reference in their entirety.

### TECHNICAL FIELD

The present disclosure provides, inter alia, fruit and vegetable products and methods of making the fruit and vegetable products.

### BACKGROUND

Dried fruits and vegetables have gained popularity as a nutritious snack, but many fruits and vegetables that are fried have a high fat content and are unhealthy and unappetizing. Most fruit and vegetable snacks that are not fried are chewy rather than crunchy. Using traditional frying methods, sugars from the fruit or vegetable may leach into oil used for frying, resulting in off flavors and discoloration of the fruit or vegetable. The present invention provides fruit and vegetable products that are puffy and crispy/crunchy, while retaining most of their original shape, volume, and color.

### SUMMARY

The present disclosure is based, in part, on the discovery that puffy, crispy/crunchy fruit and vegetable products can be produced by infusing a fruit or vegetable, pre-drying it prior to frying in the presence of oil at a sub-atmospheric pressure. This sequence of infusing, pre-drying, and frying causes the fruit or vegetable to take on a crispy/crunchy texture. As a result of this process, leaching of infused sugars, juice, or bulking agents that would typically leach into the oil during a traditional frying process is mitigated. As such, this process reduces the breakdown of oil and the production of off flavors and colors in the fruit and vegetable products produced. Reducing sugar migration from the fruit or vegetable into the oil also increases recyclability of the oil and efficiency of the frying process.

Accordingly, in one aspect, the present specification provides methods of producing fruit and vegetable products. The method includes, for example infusing a whole or sliced fruit or vegetable with an infusible molecule. The method also includes at least partially pre-drying the whole or sliced fruit or vegetable. The method also includes puffing the whole or sliced fruit or vegetable under vacuum at a temperature above 70° C. while the whole or sliced fruit or vegetable is at least partially submerged or covered with an oil. The method also includes drying the whole or sliced fruit or vegetable under vacuum to a moisture content of about 0.5% to about 3%.

In some implementations, the method further includes scarifying, pricking, slicing, or scraping the whole or sliced fruit or vegetable prior to infusing the whole or sliced fruit or vegetable. In some instances, the method further includes extracting juice from the whole or sliced fruit or vegetable prior to infusing the whole or sliced fruit or vegetable.

In some implementations, the infusible molecule is selected from the group consisting of a monosaccharide, disaccharide, trisaccharide, oligosaccharide, polysaccharide, fiber, vitamins, minerals, proteins, flavors, salt, seasoning, or any combination thereof.

In some implementations, the whole or sliced fruit or vegetable is one type of fruit or vegetable and the infusible molecule is derived from a second type of fruit or vegetable.

In some implementations, the method includes pre-drying the whole or sliced fruit or vegetable at a temperature of about 20° C. to about 140° C. In some instances, the method includes pre-drying the whole or sliced fruit or vegetable to a moisture content of about 20% or above. In some instances, pre-drying the whole or sliced fruit or vegetable is performed with a convection dryer, air dryer, impingement dryer, infrared dryer, and/or air impinger.

In some implementations, exposing the whole or sliced fruit or vegetable under vacuum to heat at a temperature of about 70° C. to about 150° C. is performed with a vacuum fryer. In some instances, the method includes exposing the whole or sliced fruit or vegetable under vacuum to heat at a temperature of about 90° C. to about 140° C.

In some implementations, the vacuum is about 300 mmHg to about 760 mmHg.

In some implementations, the whole or sliced fruit or vegetable is a cranberry. In some implementations, the whole or sliced fruit or vegetable is a blueberry. In some implementations, the whole or sliced fruit or vegetable is an elderberry. In some implementations, the whole or sliced fruit or vegetable is a chokeberry. In some implementations, the whole or sliced fruit or vegetable is a lingonberry. In some implementations, the whole or sliced fruit or vegetable is a raspberry. In some implementations, the whole or sliced fruit or vegetable is a grape.

In some implementations, the method further includes coating the whole or sliced fruit or vegetable with sugar, spices, seasoning, oil, oil blend, chocolate, yogurt, flavorings, natural flavorings, or any combination thereof.

In some implementations, the oil is a vegetable oil, nut oil, fruit oil, plant oil, animal-based oil, or any mixture thereof.

In some implementations, the method also includes actively cooling the whole or sliced fruit or vegetable to a temperature between 30° C. and 50° C., to thereby produce the fruit or vegetable product.

In some instances, actively cooling the whole or sliced fruit or vegetable is performed for between 1 and 2 minutes.

In some instances, the whole or sliced fruit or vegetable is actively cooled to between 30° C. and 40° C.

In some instances, the method further includes, prior to actively cooling, passively cooling the whole or sliced fruit or vegetable under vacuum to between 70° C. and 80° C. In some instances, passively cooling the whole or sliced fruit or vegetable is performed for between 5 and 15 minutes.

In some instances, actively cooling the whole or sliced fruit or vegetable comprises convective cooling, conductive cooling, refrigeration, fan cooling, using a cooling tunnel, using a robotic trolley equipped with a cooling system, and/or exposing the whole or sliced fruit or vegetable to ice, e.g., dry ice, or any combination thereof.

In another aspect, the present specification provides for a fruit or vegetable product produced by any of the methods recited herein.

In another aspect, the present specification provides a method for producing a fruit or vegetable product. The method includes extracting juice from the whole or sliced fruit or vegetable prior to infusing the whole or sliced fruit or vegetable. The method also includes infusing a whole or sliced fruit or vegetable with an infusion solution, wherein the infusion solution comprises a fractionated juice. The method also includes puffing the whole or sliced fruit or vegetable under vacuum at a temperature above 70° C. while the whole or sliced fruit or vegetable is at least partially submerged or covered with an oil. The method also includes drying the whole or sliced fruit or vegetable under vacuum to a moisture content of about 0.5% to about 3%.

In some implementations, the infusion solution further includes a sugar solution and/or another bulking agent.

In some implementations, the whole or sliced fruit or vegetable is a fruit of one type and wherein the infusion solution is derived from a fruit or another type.

In some implementations, the method further includes scarifying, pricking, slicing, or scraping the whole or sliced fruit or vegetable prior to exposing the whole or sliced fruit or vegetable under vacuum.

In some implementations, the method further includes at least partially pre-drying the whole or sliced fruit or vegetable. In some instances, the method includes pre-drying the whole or sliced fruit or vegetable at a temperature of about 20° C. to about 140° C. In some instances, the method includes pre-drying the whole or sliced fruit or vegetable to a moisture content of about 20% or above. In some instances, pre-drying the whole or sliced fruit or vegetable is performed with a convection dryer, air dryer, impingement dryer, infrared dryer, and/or air impinger.

In some implementations, exposing the whole or sliced fruit or vegetable under vacuum to heat at a temperature of above 70° C. is performed with a vacuum fryer. In some instances, the method includes exposing the whole or sliced fruit or vegetable under vacuum to heat at a temperature of 90° C. to 140° C.

In some implementations, the vacuum is about 300 mmHg to about 760 mmHg.

In some implementations, the whole or sliced fruit or vegetable is a cranberry. In some implementations, the whole or sliced fruit or vegetable is a blueberry. In some implementations, the whole or sliced fruit or vegetable is an elderberry. In some implementations, the whole or sliced fruit or vegetable is a chokeberry. In some implementations, the whole or sliced fruit or vegetable is a lingonberry. In some implementations, the whole or sliced fruit or vegetable is a raspberry. In some implementations, the whole or sliced fruit or vegetable is a grape.

In some implementations, the method further includes coating the whole or sliced fruit or vegetable with sugar, spices, seasoning, oil, oil blend, chocolate, yogurt, flavorings, natural flavorings, or any combination thereof.

In some implementations, the oil is a vegetable oil, nut oil, fruit oil, plant oil, animal-based oil or any combination thereof.

In some implementations, the method also includes actively cooling the whole or sliced fruit or vegetable to a temperature between 30° C. and 50° C., to thereby produce the fruit or vegetable product.

In some instances, actively cooling the whole or sliced fruit or vegetable is performed for between 1 and 2 minutes.

In some instances, the whole or sliced fruit or vegetable is actively cooled to between 30° C. and 40° C.

In some instances, the method further includes, prior to actively cooling, passively cooling the whole or sliced fruit or vegetable under vacuum to between 70° C. and 80° C. In some instances, passively cooling the whole or sliced fruit or vegetable is performed for between 5 and 15 minutes.

In some instances, actively cooling the whole or sliced fruit or vegetable comprises convective cooling, conductive cooling, refrigeration, fan cooling, using a cooling tunnel, using a robotic trolley equipped with a cooling system, and/or exposing the whole or sliced fruit or vegetable to ice, e.g., dry ice, or any combination thereof.

In another aspect, the present specification provides for a fruit or vegetable product produced by any of the methods recited herein.

In another aspect, the present specification provides a fruit or vegetable product including a moisture content of approximately 0.5 to 3%, a sugar and/or a bulking agent content of approximately 40 to 95° Brix, an oil content of approximately 4 to 20%, and wherein the fruit or vegetable product is infused with a fractionated juice.

As used herein, the term “fruit” refers to firm fruits, soft fruits, sliced pieces with skin remaining, and/or scarified/pricked/scraped fruit, which are well-known in the art, and described herein. In some instances, the fruit material can be a berry. In some instances, the berry can be a cranberry, blueberry, elderberry, chokeberry, lingonberry, raspberry, gooseberry, huckleberry, strawberry, blackberry, cloudberry, grape, blackcurrant, redcurrant, white currant, and/or or any mixture thereof.

“Firm fruits” are fruits that resist structural collapse under substantial compression. Examples include cranberries, apples, and cherries. On the other hand, “soft fruits” are more readily collapsed. Examples include blueberries, raspberries, blackberries, kiwi, guava, mango, and passion.

As used herein, the term “berry” refers to fruits that are well-known in the art, and described herein. In some instances, the berry can be cranberry, blueberry, elderberry, chokeberry, lingonberry, raspberry, gooseberry, huckleberry, strawberry, blackberry, cloudberry, grape, blackcurrant, redcurrant, white currant, and/or or any mixture thereof. Other fruits are amenable to treatment in accordance with the presently described methods, such as cherries, mango, pineapple, kiwi, guava, date, apple, apricot, plum, prune, pear, passion, and peach, among others.

“Vegetables” can include cabbage, turnip, radish, carrot, celery, parsnip, beetroot, lettuce, beans, peas, potato, eggplant, tomato, cucumber, squash, onion, garlic, leek, pepper, spinach, yam, sweet potato, and cassava.

Unless otherwise defined, all technical terms used herein have the same meaning as commonly understood by one of ordinary skill in the art to which this invention belongs. Methods and materials are described herein for use in the present invention; other suitable methods and materials known in the art can also be used. The methods, materials, and examples are illustrative only and not intended to be limiting. All publications, patent applications, patents, and other references mentioned herein are incorporated by reference in their entirety. In case of conflict, the present specification, including definitions, will control.

Other features and advantages of the invention will be apparent from the following detailed description and figures, and from the claims.

### DESCRIPTION OF DRAWINGS

FIG. 1 is a schematic of a process for producing a crispy/crunchy fruit or vegetable product via infusing with a sugar solution, pre-drying, and vacuum frying.

FIG. 2 is a schematic of a process for producing a crispy/crunchy fruit or vegetable product via extracting, infusing with a sugar solution and fractionated juice, and vacuum frying.

FIG. 3A is a photograph of fried and infused cranberries submerged in oil.

FIG. 3B is a photograph of oil used to fry infused cranberries that were not pre-dried.

FIG. 3C is a photograph of fried, infused and pre-dried cranberries submerged in oil.

FIG. 3D is a photograph of oil used to fry infused and pre-dried cranberries.

### DETAILED DESCRIPTION

Dried fruits and vegetables have gained popularity as a nutritious snack. Consumer concern on high sugar snacks and increased acceptability of healthy oil has made fried fruits and vegetables a healthy alternative to traditional fried snacks, such as potato chips and French fries. However, to maintain the structural integrity of fruits and vegetables during frying, fruits and vegetables are typically infused with bulking agents, such as sugar prior to frying. These infused fruits and vegetables typically still contain more than 70% moisture. Vacuum or reduced pressure frying instead of frying under atmospheric pressure has become popular due to less degradation of frying oil and lower absorption of fat in the product. Vacuum frying also allows fruits and vegetables to have a puffed structure upon drying. However, frying of infused fruits or vegetables, either under atmospheric pressure or under vacuum, can result in the leakage of sugars and other bulking agents into the frying oil. This leakage of sugars and bulking agents can result in product loss, rancidity and development of other off flavors or colors, and lower shelf-life of the oil. Moreover, inconsistencies of the infusion syrup leakage during the frying process may result in inconsistencies of product quality.

Additionally, if the frying unit is not in proximity to the infusion unit, the infused fruit or vegetable is transported, often under frozen condition to the location of the frying unit. Freezing of a large quantity of water causes structural damage to the fruit or vegetable resulting in reduced puffing of the finished fruits or vegetable product. Moreover, transportation of wet infused fruit is cumbersome and expensive. The present disclosure provides efficient methods to dry fruits and vegetables and produce fruit and vegetable products that can be characterized as puffy and crispy/crunchy.

In addition, lower temperature frying under vacuum may lower the effects of heat on infused fruits and vegetables that tend to brown under high temperature. As such, the present disclosure also provides a solution to create an infused fruit or vegetable that is less dark and brighter in appearance after it has gone through vacuum frying process.

### Fruit and Vegetable Products

Fruit and vegetable products, as described herein, are fruits and vegetables that retain most of its original shape and volume, e.g., greater than or about 55%, 60%, 65%, 70%, 75%, 80%, 85%, 90%, or greater than or about 95% of the volume of the original fruit and vegetable. In one embodiment, the fruit and vegetable products contain whole fruits or whole vegetables. In some embodiments, the fruit and vegetable products are slices, wedges, or chunks of fruits or vegetables. In some embodiments, the fruit and vegetable products have a moisture content of about 0.5% to about 3% moisture, e.g., about 0.5% to about 1%, about 0.5% to about 2%, about 0.5% to about 3%, about 1% to about 2%, about 1% to about 3%, about 2% to about 3%, See, Table.

While berries are used as an example, skilled practitioners will appreciate that the methods described herein can be readily adapted to be performed on any fruit or vegetable described herein. Whole berries include, e.g., berries that have not been processed in any way, berries that have been extracted to remove juice, and berries that have been extracted to remove juice and subsequently infused with an infusion syrup comprising sugar and/or other infusible molecules, e.g., fiber or maltodextrin.

TABLE
Properties of an Example of a Puffy,
Crispy/Crunchy Cranberry Product

| PROPERTY | VALUE | |
|---|---|---|
| Moisture Content | 0.5-3% | |
| Hardness | 500-15000 | g |
| Porosity | 0.4-0.8% | |
| Bulk Density | 0.1-0.4 | g/cc |
| Apparent Density | 0.2-0.7 | g/cc |
| True Density | 0.3-1.5 | g/cc |

The fruit and vegetable products produced using the methods described herein have unique characteristics. In one embodiment, they are relatively crunchy, e.g., as compared to fruit or vegetable that has been simply dried using a prior art method, which typically have a crumbly/powdery texture. The products can have a hardness of about 500 to about 5000 g, e.g., about 1100 to about 4900 g, about 1500 to about 4500 g, about 2000 to about 4000 g, or about 2500 to about 3500 g. Other products produced by the present methods have a hardness of about 500 to about 15000 g, e.g., about 600 to about 14000 g, about 700 to about 13000 g, about 800 to about 12000 g, about 900 to about 11000 g, about 1000 to about 10000 g, about 1100 to about 9000 g, about 600 to about 9000 g, about 700 to about 8000 g, about 700 to about 7000 g, about 800 to about 6000 g, about 900 to about 5000 g, about 1000 to about 4000 g, about 1100 to about 3000 g, about 1200 to about 2000 g, or about 1000 g, 1200 g, 1500 g, 1700 g, 2000 g, 2500 g, 3000 g, 3500 g, 4000 g, 4500 g, or about 7000 g. Skilled practitioners will appreciate that while the peak force required to break a commercially-available freeze-dried fruit or vegetable (which can be referred to as the hardness of the fruit or vegetable) might be similar in value to the products produced by the presently described methods, the nature of force required to break the presently described products is different from a commercially-available freeze-dried fruit or vegetable. Skilled practitioners will appreciate some variability with fruits and vegetables, hence a very high or low force may occasionally be required to break the products described herein.

The fruit and vegetable products can have a porosity of about 0.4 to about 0.8%, e.g., about 0.45 to about 0.75%, about 0.5 to about 0.7%, or about 0.55 to about 0.65%. For example, the fruit or vegetable products can have a porosity of about 0.41%, 0.42%, 0.43%, 0.44%, 0.45%, 0.46%, 0.47%, 0.48%, or about 0.49%. The fruit and vegetable products can have a bulk density of about 0.1 to about 0.4 g/cc, e.g., about 0.11 to about 0.29 g/cc, about 0.13 to about 0.27 g/cc, about 0.19 to about 0.26 g/cc, about 0.25 to about 0.4 g/cc, about 0.3 to about 0.4 g/cc, about 0.1 to about 0.35 g/cc, about 0.2 to about 0.35 g/cc, or about 0.25 g/cc, 0.3 g/cc, or about 0.35 g/cc. The products can have an apparent density of, for example, about 0.2 g/cc to about 0.7 g/cc, e.g., about 0.25 g/cc to about 0.45 g/cc, about 0.28 g/cc to about 0.42 g/cc, about 0.3 g/cc to about 0.65 g/cc, about 0.4 g/cc to about 0.7 g/cc, about 0.5 g/cc to about 0.7 g/cc, about 0.6 g/cc to about 0.7 g/cc, or about 0.2 g/cc, 0.3 g/cc, 0.4 g/cc, 0.5 g/cc, 0.6 g/cc, or about 0.7 g/cc. The products can have a true density of, for example, about 0.3 g/cc to about 1.5 g/cc, e.g., about 0.6 g/cc to about 1.4 g/cc, about 0.7 g/cc to about 1.3 g/cc, about 0.8 g/cc to about 1.2 g/cc, about 0.9 g/cc to about 1.1 g/cc, about 0.5 g/cc to about 1.5 g/cc, about 0.3 g/cc to about 1.2 g/cc, about 1.0 g/cc to about 1.5 g/cc, or about 0.3 g/cc, 0.5 g/cc, 0.7 g/cc, 1 g/cc, 1.2 g/cc, or about 1.5 g/cc. In some embodiments, the fruit and vegetable products are puffy, but not crispy.

The fruit and vegetable products can have an oil content between 4% and 20%, e.g. about 4% to about 6%, about 6% to about 8%, about 8% to about 10%, about 10% to about 12%, about 12% to about 14%, about 14% to about 16%, about 16% to about 18%, about 18% to about 20%, or about 4%, about 6%, about 8%, about 10%, about 12%, about 14%, about 16%, about 18%, or about 20%.

Skilled practitioners will appreciate that the moisture content, hardness, porosity, and density of the fruit and vegetable products can be determined using a number of methods known in the art. However, exemplary methods that can be used for determining the values described in the present specification are described below.

### Methods to Produce Fruit and Vegetable Products

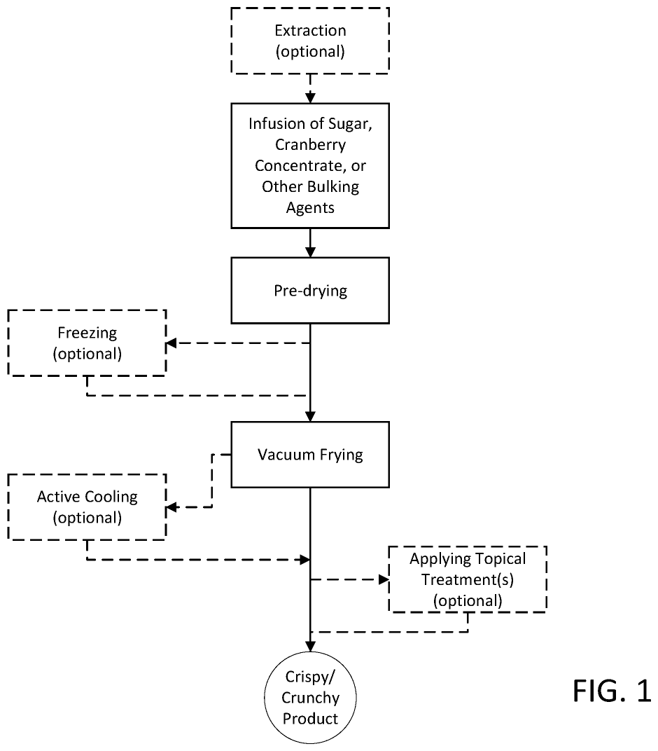

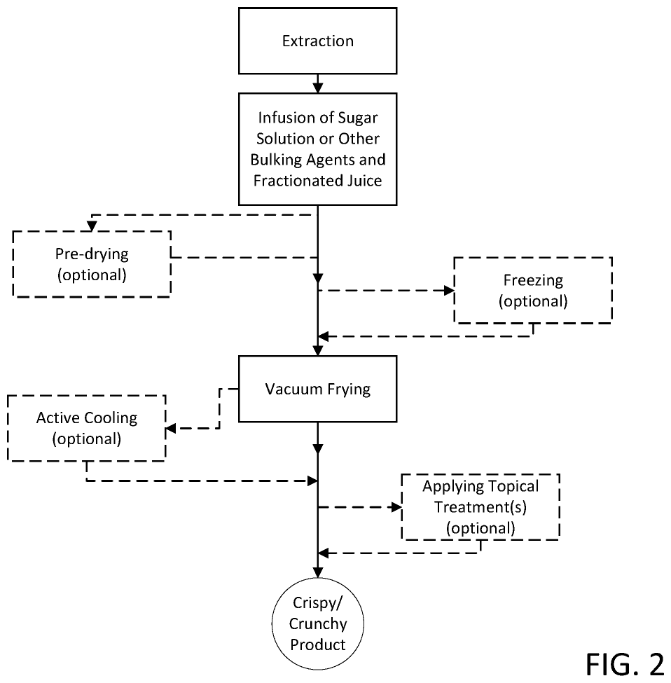

The fruit and vegetable products described herein can be produced in a number of ways. Exemplary schemes are described in the flowcharts shown in FIGS. 1-2. Whole berries are used for illustrative purposes only, and skilled practitioners will appreciate that the methods described herein can be readily adapted for any fruit or vegetable. Further, while whole berries are used for illustrative purposes, skilled practitioners will appreciate that the methods can also be used on slices (e.g., cranberries cut in roughly three to four slices), wedges, or chunks, of any fruit or vegetable described herein. Referring to the flowcharts described in FIGS. 1-2, berries, e.g., frozen whole berries, such as cranberries, are sorted and cleaned in preparation for the process. Optionally, berries are then scarified, pricked, and/or abraded. Scarification, pricking, and abrasive methods are well known in the art, and any method can be used in the present methods.

### Infusion

To produce a crispy/crunchy fruit and vegetable product, a higher solid content in the fruit or vegetable may be useful. While some fruits and vegetables, e.g., grapes, have a high solid content, e.g., a solid content of greater than or about 15° Brix, other fruits and vegetables, e.g., cranberries, have a relatively low solid content, e.g., a solid content of less than or about 10° Brix. To create a crunchier fruit and vegetable product, the fruit or vegetable may optionally be infused, e.g., to about 20° Brix to about 55° Brix, about 20° Brix to about 30° Brix, about 30° Brix to about 50° Brix, about 35° Brix to about 45° Brix, about 40° Brix to about 55° Brix, about 45° Brix to about 55° Brix, or about 50° Brix to about 55° Brix, by, for example, using a countercurrent infuser. Any art known method of infusing a berry can be used. Further, the infusion material can include any art-known infusible molecule, e.g., sugar, carbohydrates, maltodextrins, sugar alcohols, soluble fibers, salts such as sodium, calcium, magnesium and/or potassium salts, and/or fruit juices, e.g., apple juice, orange juice, pineapple juice, mango juice, grape juice, guava juice, strawberry juice, banana juice, kiwi juice, watermelon juice, lemon juice, and/or pomegranate juice. In another implementation, the berries may be infused with a permeate, a fractionated juice, from an ultrafiltration process. The ultrafiltration process may separate proanthocyanidins, phenolics, and other long chain molecules from a juice. The permeate has less color (e.g. bright red color) than the juice, which may be advantageous for infusion so the fruit, when fried, does not turn too dark in color. Additionally, because the permeate has less color than a non-fractionated juice, pre-drying, which reduces frying time and thereby darkening of the fruit during frying, is less necessary.

In another exemplary method, other fruits such as apples and pineapples are infused with cranberry juice concentrate or permeate along with other bulking agents with or without extracting the fruit prior to infusion.

### Pre-Drying

Berries may then be pre-dried to remove at least some moisture to achieve a moisture content that is less than that found in an untreated berry. For example, pre-drying of berries can be performed at a temperature of about 20° C. to about 140° C., e.g., about 30° C. to about 140° C., about 40° C. to about 140° C., about 50° C. to about 140° C., about 60° C. to about 140° C., about 70° C. to about 140° C., about 80° C. to about 140° C., about 90° C. to about 140° C., about 100° C. to about 140° C., about 110° C. to about 140° C., about 120° C. to about 140° C., about 130° C. to about 140° C., about 70° C. to about 130° C., about 70° C. to about 120° C., about 70° C. to about 110° C., about 70° C. to about 100° C., about 70° C. to about 90° C., about 70° C. to about 80° C., about 20° C. to about 130° C., about 20° C. to about 120° C., about 20° C. to about 110° C., about 20° C. to about 100° C., about 20° C. to about 90° C., about 20° C. to about 80° C., about 20° C. to about 70° C., about 20° C. to about 60° C., about 20° C. to about 50° C., about 20° C. to about 40° C., about 20° C. to about 30° C., or about 20° C., 30° C., 40° C., 50° C., 60° C., 70° C., 80° C., 90° C., 100° C., 110° C., 120° C., 130° C., or about 140° C., to dry the berries to about 20% moisture content or above, e.g., about 25%, 30%, 35%, 40%, 45%, 50%, 55%, 60%, 65%, 70%, 75%, or about 80%. Skilled practitioners will appreciate that any methods or apparatuses can potentially be used to dehydrate a whole or sliced fruit or vegetable, e.g., convection dryer, air dryer, infrared oven, and/or air impinger.

Pre-drying the berries allows for less of the infusion syrup to mix with the oil during frying. As such, the berries better maintain their Brix level through the vacuum frying process as less infusion syrup leaches from the berries into the oil. Less infusion syrup leaving the berries allows the oil to be reused for a larger number of frying cycles, which saves costs. Although sucrose and glucose do not start caramelization until the temperature reaches 160° C., which is higher than the process described in this invention, much of the sugars present in the infusion syrup gets inverted (converted) to glucose and fructose due to high acid present in fruit juice, for example cranberry juice. Fructose caramelizes at a much lower temperature, such as 110° C., within the operating conditions described in the invention. Fructose present in the leached out syrup in oil caramelizes as it is heated, which causes the oil to take on a darker color. This darker color is then passed onto the fried product, which is undesirable.

Health concerns have replaced the use of trans-fats with high oleic and other unsaturated oils for most of the frying operations in the US. These unsaturated oils are more prone to oxidation than their predecessor trans-fats. Sugar leakage in these high oleic and other unsaturated frying oils is particularly problematic since reducing sugars are known to be strong pro-oxidants. Glucose and fructose, naturally present in fruit or are converted from sucrose, and other reducing mono and disaccharides may hasten oxidation of unsaturated fatty acids present when the leach out from the infused fruit.

During the pre-drying process, the berries shrink, which may not be ideal when producing a puffed berry product. However, the pre-dried berries, when puffed under vacuum in the presence of oil, puff back to roughly their original shape.

Freezing/Temperature Control after Pre-Drying

In some implementations, the partially dried fruit or vegetable is chilled or frozen after it is partially dried. The partially dried fruit or vegetable may be frozen to a temperature of approximately 0° C. to −40° C. Freezing the partially dried fruit or vegetable before frying may be advantageous because it helps to extend the shelf life of the product.

In some implementations, the partially dried fruit or vegetable is left at room temperature, at approximately 15° C. to approximately 35° C., after it is partially dried.

### Vacuum Frying

In one exemplary method, partially dried fruit or vegetable products, in a relatively crumbly/powdery state after pre-drying, can be placed under vacuum at a temperature above the glass transition temperature to expand the dried fruit or vegetable. While the berries are exposed to vacuum for expansion, they are also at least partially submerged in oil such that they are vacuum fried. The oil may be a vegetable oil, nut oil, fruit oil, plant oil, or animal-based oil, or any mixture thereof. In some embodiments, the vacuum is applied prior to submerging the berries. In some embodiments, the berries are at least partially submerged in the oil as the vacuum is applied. In some embodiments, the berries are placed in a frying basket which may be controlled to be lifted out of and lowered into the oil during the process. In some embodiments, the basket is frequently lifted out of the oil during the frying process. Frequently lifting the basket out of the oil during frying may allow for less oil to be absorbed during the frying process.

The temperature of the vacuum frying is approximately 70° C. to 150° C., e.g., about 70-80° C., about 70-90° C., about 70-100° C., about 70-110° C., about 70-120° C., about 70-130° C., about 70-140° C., about 80-90° C., about 80-100° C., about 80-110° C., about 80-120° C., about 80-130° C., about 80-140° C., about 80-150° C., about 90-100° C., about 90-110° C., about 90-120° C., about 90-130° C., about 90-140° C., about 90-150° C., about 100-110° C., about 100-120° C., about 100-130° C., about 100-140° C., about 100-150° C., about 110-120° C., about 110-130° C., about 110-140° C., about 110-150° C., about 120-130° C., about 120-140° C., about 120-150° C., about 130-140° C., about 130-150° C., about 140-150° C., or about 70° C., about 80° C., about 90° C., about 100° C., about 110° C., about 120° C., about 130° C., about 140° C., or about 150° C.

The vacuum may be pulled at about 300-760 mmHg, e.g., about 300-400 mmHg, about 300-500 mmHg, about 300-600 mmHg, about 300-700 mmHg, about 700-760 mmHg, about 600-760 mmHg, about 500-760 mmHg, about 400-760 mmHg, about 300 mmHg, 400 mmHg, 500 mmHg, 600 mmHg, 700 mmHg, 760 mmHg. Skilled practitioners will appreciate that any methods or commercially available apparatuses can potentially be used to fry a whole or sliced fruit or vegetable. For example, the berries can be fried in the same apparatus used to expand the berries or in a different apparatus and at the same vacuum or a reduced vacuum.

For a vacuum frying procedure as described, a typical approximate frying time would be between 10-12 minutes. This is less than a traditional frying time of approximately 17-20 minutes.

### Cooling

The berries can then be cooled while still under vacuum to a temperature of about 20° C. to about 90° C., e.g., to about 20° C. to about 80° C., about 20° C. to about 70° C., about 20° C. to about 60° C., about 20° C. to about 50° C., about 20° C. to about 40° C., about 20° C. to about 30° C., or about 20° C., 30° C., 40° C., 50° C., 60° C., 70° C., 80° C., 90° C. Skilled practitioners will appreciate that any method or apparatus can potentially be used to cool the berries. The vacuum may be released before or after cooling.

For example, the berries can be passively cooled under vacuum from approximately 120-122° C. (reached during vacuum frying) to between 70° C. and 110° C., e.g., between 70° C. and 80° C., between 70° C. and 90° C., between 70° C. and 100° C., between 80° C. and 90° C., between 80° C. and 100° C., between 80° C. and 110° C., between 90° C. and 100° C., between 90° C. and 110° C., or between 100° C. and 110° C. This passive cooling takes approximately 5-15 minutes and helps to achieve a desired moisture content and retain color of the berries. Passive cooling occurs when the berries are allowed to cool down by exposure to air having a temperature that is less than that of the berries. For example, berries can be passively cooled by exposing the berries to ambient temperature air.

In some instances, the vacuum is removed after passive cooling. The berries are then actively cooled. Active cooling occurs when an active step is taken to cool the berries. For example, active cooling can be performed using convective cooling, conductive cooling, refrigeration, fan cooling, using a cooling tunnel, robotic trolley equipped with a cooling system, and/or exposure to ice, e.g., dry ice, or any combination thereof. Active cooling does not include using passive cooling methods, e.g., allowing the temperature of the berries to decrease by exposure to ambient temperature air. The berries are actively cooled from between 70° C. and 110° C. to between 30° C. and 50° C., e.g., between 30° C. and 35° C., between 30° C. and 40° C., between 30° C. and 45° C., between 35° C. and 40° C., between 35° C. and 45° C., between 35° C. and 50° C., between 40° C. and 45° C., between 40° C. and 50° C., or between 45° C. and 50° C. Actively cooling the berries from between 70° C. and 110° C. to between 30° C. and 50° C. is accomplished in under approximately 5 minutes, e.g., under 1 minute, under 2 minutes, under 3 minutes, under 4 minutes, between 30 seconds and 1 minute, between 1 minute and 2 minutes, between 2 minutes and 3 minutes, between 3 minutes and 4 minutes, or between 4 minutes and 5 minutes. Skilled practitioners will appreciate that any methods or apparatuses can potentially be used to actively cool the berries, for example, convective cooling methods, conductive cooling methods, exposure to dry ice, refrigeration, fans, a cooling tunnel, a robotic trolley equipped with a cooling system, etc. Additionally, active cooling may take place under vacuum or at atmospheric pressure. Active cooling may take place inside the fryer or outside of the fryer in another, separate chamber.

The glass transition temperature of the dried berries varies depending on the type of berry and the moisture content of the finished products. At a moisture content of about 1 to 3%, the glass transition temperature of dried berries is about 40° C. to about 50° C. The glass transition temperature is the temperature at which a material changes from a pliable, amorphous state to a hard, brittle state, often referred to as a glassy state. The glass transition temperature increases as the berries are dried and therefore, at a critical moisture content, the berries become crunchy at room temperature. As the berries are actively cooled to a temperature below the glass transition temperature, the berries set in a puffed, rigid state. Actively cooling the berries minimizes a likelihood that the structure of the berries will collapse.

Following release of the vacuum, the berries can optionally be packaged, e.g., in a high moisture barrier package.

### Combining Method Steps

As shown in FIG. 1, berries may optionally be extracted, e.g. by countercurrent extraction, to remove juice from the berries. The berries are then infused with a sugar solution, cranberry concentrate, or another bulking agent (as listed above), e.g. by countercurrent infusion. The berries are then pre-dried at a temperature of about 20° C. to about 140° C. down to a moisture content of approximately 40-80% The berries are then optionally frozen to a temperature of approximately 0 to 40° C. The berries may be stored in this frozen state. The berries may be optionally thawed. The berries are then vacuum fried while at least partially submerged in oil, as discussed above. The oil may be a vegetable oil, nut oil, fruit oil, plant oil, animal-based oil, or any mixture thereof. Because the berries have been pre-dried, less sugar leakage may occur between the berry and the oil. Because less sugar leakage occurs, the oil is more stable, and may be reused for further frying treatments. After frying, the berries may optionally be actively cooled from a temperature of about 70-110° C. down to between 30° C. and 50° C. The berries, after cooling, may be optionally applied with a topical treatment and then packaged.

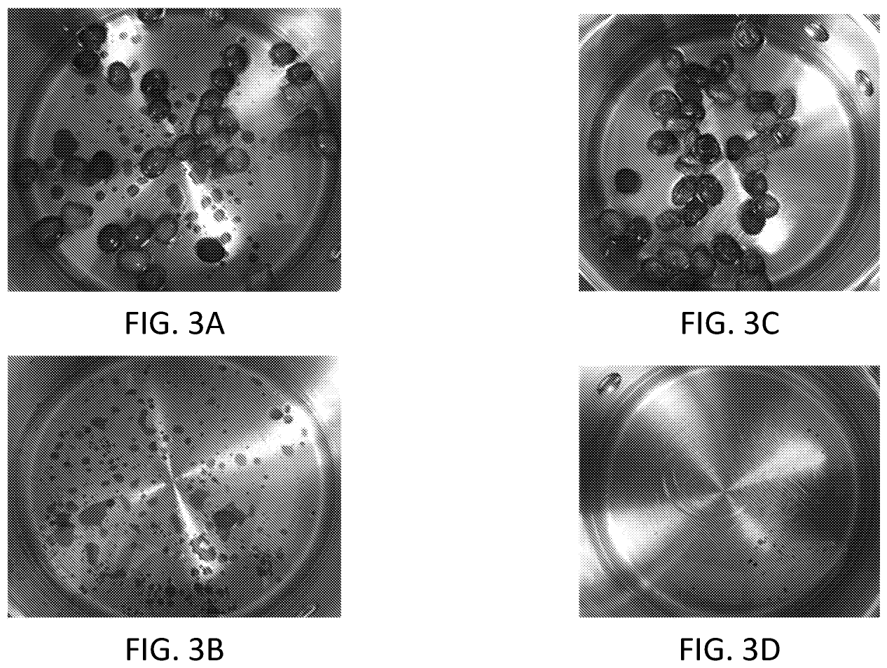

FIGS. 3A and 3B are example photographs of infused cranberries that were not pre-dried before frying in oil, and the oil used for frying, respectively. FIGS. 3C and 3D are example photographs of infused cranberries that were pre-dried before frying in oil, and the oil used for frying, respectively. The oil in FIGS. 3A and 3B has experienced color, sugar, and/or other bulking agent transfer from the berries that were not pre-dried. By contrast, FIGS. 3C and 3D are example photographs of infused cranberries that were pre-dried. The color, sugar and/or, other bulking agent transfer has been minimized allowing for the oil to be reused and maintaining the proper sugar and/or other bulking agent through the frying process.

In another implementation, as shown in FIG. 2, berries are extracted, e.g. by countercurrent extraction, to remove juice from the berries. The berries are then infused, e.g. by countercurrent infusion, with a sugar solution or other bulking agents (as described above) as well as a fractionated juice. The fractionated juice has less color than a non-fractionated juice. The berries may then pre-dried at a temperature of about 20° C. to about 140° C. down to a moisture content of approximately 40-80%. The pre-drying step is not required after infusion with a fractionated juice as the fractionated juice has less color than a non-fractionated juice or untreated berry, so the darkness added by frying does not over-darken the berries. As such, the color after vacuum frying may be maintained giving the berry a lighter color. The berries are then optionally frozen to a temperature of approximately 0 to 40° C. The berries may be stored in this frozen state. The berries are then vacuum fried while at least partially submerged in oil, as discussed above. The oil may be a vegetable oil, nut oil, fruit oil, plant oil, animal-based oil, or any mixture thereof. After frying, the berries may optionally be actively cooled from a temperature of about 70-110° C. down to between 30° C. and 50° C. The berries, after cooling, may be optionally applied with a topical treatment and then packaged.

### Food Products

The present disclosure also provides food products that include the fruit and/or vegetable products described herein. For example, the fruit and/or vegetable product can be included as an ingredient in ready to eat cereals. Such food products can also be in the form of a mass, e.g., a cereal bar, protein bar, granola bar, or chocolate bar. For example, fruit and vegetable products can be admixed with cereal and formed into a bar such as with a binder. In some embodiments, the bars can include one or more separate layer(s) or region(s) that include(s) the fruit or vegetable product. Alternatively, or in addition, bars can include an outer coating of the fruit and/or vegetable product, i.e., where the fruit and/or vegetable product coats at least a part of, e.g., the entire, surface of the bar. Fruit and vegetable products described herein can be coated with a coating to alter the taste and/or appearance of the product, e.g., sugar, spices, seasonings (e.g., chipotle lime), oils, oil blends, chocolate, yogurt, flavorings, natural flavorings, or other suitable ingredients to affect taste and texture. For example, a fruit and vegetable product may be coated with a sunflower oil (or other suitable oil type) blend containing an oil-soluble flavoring.

The fruit and vegetable products can also be added to products such as confections (e.g., chocolates) and salads (e.g., prepackaged salads and salad kits). The fruit and vegetable products can be added to a variety of other food products such as dry mixes for snack or trail mixes.

The fruit and vegetable products are also suitable for inclusion into a wide variety of dairy products. For example, the fruit and vegetable products can be added to yogurt to provide products that not only provide the nutrition and taste appeal of fruit or vegetable, but also provide high levels of fiber.

The fruit and vegetable products disclosed herein can be used in or as nutraceuticals and/or as food supplements. For example, the fruit and vegetable products can be used to supplement a food or beverage to enhance the health benefits conferred by the food or beverage. For example, the products can be used to supplement yogurt. The products can be packaged in bulk or packaged for individual servings and shipped to the consumer. For example, each package of products can contain multiple dried fruit and/or vegetable products in a sealed container, where the container does not transmit much moisture vapor, e.g., a low-moisture or an airtight, waterproof container. Alternatively, or in addition, a package of fruit and/or vegetable products can include a desiccant to maintain a lower moisture environment.

### EXAMPLES

The invention is further described in the following examples, which do not limit the scope of the invention described in the claims.

### Example 1

Frozen cranberries were slightly thawed to make the skin of the berries slightly pliable. Partially thawed berries were then scarified and infused with sugar syrup to 25° Brix. The infused berries were then dried to 50° Brix using a convection oven at 90° C. Sunflower oil at 0.5% of the weight of partially dried berries was sprayed on the surface of the partially dried wrinkled berries. The berries were then placed in a vacuum fryer at 29.7 in Hg vacuum (754 mm Hg vacuum) preheated to 127° C. The oven temperature was turned off and the vacuum chamber was allowed to cool down to 40° C. before the vacuum was released from the chamber.

### Example 2

Frozen cranberries were slightly thawed to make the skin of the berries slightly pliable. Partially thawed berries were then scarified and infused with a sugar syrup to about 250 Brix. The infused berries were then dried to 50° Brix using a convection oven at about 90° C. Sunflower oil at 0.5% of the weight of partially dried berries was sprayed on the surface of the partially dried wrinkled berries. After convection drying the berries were frozen. The berries were then placed in a vacuum fryer at 25-27 inches of Hg vacuum and heated to 120-122° C. for 8-10 minutes. The cranberries were then cooled while under vacuum in a basket above the oil for about 5-15 minutes until the target moisture content of 0.5-3% was achieved. By continuing to dry the cranberries above the oil under vacuum, the color of the cranberries is retained and not darkened. The product was then removed from the vacuum at about 70-80° C., and then actively cooled to below 50° C. This active cooling step is critical to maintain the puffed rigid appearance of the berries. This minimizes the puffed berries from collapsing.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for producing a fruit or vegetable product, wherein the method comprises:
infusing a whole or sliced fruit or vegetable with an infusible molecule;
at least partially pre-drying the whole or sliced fruit or vegetable;
puffing the whole or sliced fruit or vegetable under vacuum at a temperature above 70° C. while the whole or sliced fruit or vegetable is at least partially submerged or covered with an oil; and
drying the whole or sliced fruit or vegetable under vacuum to a moisture content of about 0.5% to about 3%, to thereby produce the fruit or vegetable product.

2. The method of claim 1, wherein the method further comprises scarifying, pricking, slicing, or scraping the whole or sliced fruit or vegetable prior to infusing the whole or sliced fruit or vegetable.

3. The method of claim 2, wherein the method further comprises extracting juice from the whole or sliced fruit or vegetable prior to infusing the whole or sliced fruit or vegetable.

4. The method of claim 1, wherein the infusible molecule is selected from the group consisting of a monosaccharide, disaccharide, trisaccharide, oligosaccharide, polysaccharide, fiber, vitamins, minerals, proteins, flavors, salt, seasoning, or any combination thereof.

5. The method of claim 1, wherein the whole or sliced fruit or vegetable is one type of fruit or vegetable and the infusible molecule is derived from a second type of fruit or vegetable.

6. The method of claim 1, wherein the method comprises pre-drying the whole or sliced fruit or vegetable at a temperature of about 20° C. to about 140° C. and to a moisture content of about 20% or above.

7. (canceled)

8. (canceled)

9. The method of claim 1, wherein exposing the whole or sliced fruit or vegetable under vacuum to heat at a temperature of about 70° C. to about 150° C. is performed with a vacuum fryer.

10. The method of claim 9, wherein the method comprises exposing the whole or sliced fruit or vegetable under vacuum to heat at a temperature of about 90° C. to about 140° C.

11. The method of claim 1, wherein the vacuum is about 300 mmHg to about 760 mmHg.

12. The method of claim 1, wherein the whole or sliced fruit or vegetable is a cranberry, blueberry, elderberry, chokeberry, raspberry, lingonberry, or grape.

13-19. (canceled)

20. The method of claim 1, wherein the oil is a vegetable oil, nut oil, fruit oil, plant oil, animal-based oil, or any mixture thereof.

21-26. (canceled)

27. A method for producing a fruit or vegetable product, wherein the method comprises:
extracting juice from a whole or sliced fruit or vegetable prior to infusing the whole or sliced fruit or vegetable;
infusing a whole or sliced fruit or vegetable with an infusion solution, wherein the infusion solution comprises a fractionated juice;
puffing the whole or sliced fruit or vegetable under vacuum at a temperature above 70° C. while the whole or sliced fruit or vegetable is at least partially submerged or covered with an oil; and
drying the whole or sliced fruit or vegetable under vacuum to a moisture content of about 0.5% to about 3%, to thereby produce the fruit or vegetable product.

28-52. (canceled)

53. A fruit or vegetable product comprising:
a moisture content of approximately 0.5 to 3%;
a sugar and/or a bulking agent content of approximately 40 to 95° Brix; and
an oil content of approximately 4 to 20%.

54. The fruit or vegetable product of claim 53, wherein the fruit or vegetable product is infused with a fractionated juice.

55. The fruit or vegetable product of claim 53, wherein the fruit or vegetable has a hardness of approximately 500 g to 1500 g.

56. The fruit or vegetable product of claim 53, wherein the fruit or vegetable has a porosity of approximately 0.4% to 0.8%.

57. The fruit or vegetable product of claim 53, wherein the fruit or vegetable has a bulk density of approximately 0.1 g/cc to 0.4 g/cc.

58. The fruit or vegetable product of claim 53, wherein the fruit or vegetable has a apparent density of approximately 0.2 g/cc to 0.7 g/cc.

59. The fruit or vegetable product of claim 53, wherein the fruit or vegetable has a true density of approximately 0.3 g/cc to 1.5 g/cc.

60. The fruit or vegetable product of claim 53, wherein the fruit or vegetable product is a cranberry, blueberry, elderberry, chokeberry, raspberry, lingonberry, or grape.
